(19) United States
(12) Patent Application Publication
(10) Pub. No.: US 2007/0193104 A1
(43) Pub. Date: Aug. 23, 2007

(54) Tool and method for threading small eyelets

(76) Inventor: Richard Scott Molyneux, Sandgate (AU)

Correspondence Address: Stan Collier. Esq., PO Box 6136, Holyoke, MA, 01040, US

(21) Appl. No.: 11/788,729

(22) Filed: Apr. 23, 2007

(30) Foreign Application Priority Data
Feb. 9, 2007 (AU) 2007200565
Feb. 14, 2006 (AU) 2006900704
Sep. 25, 2006 (AU) 2006905282

(51) Int. Cl. A01K 97/00; A01K 83/00

(52) U.S. Cl. 43/4; 43/43.16

(57) ABSTRACT

A threading tool (1) and method are provided for threading an eye of an eyed article (30). The tool (1) comprises a pair of cooperating elongate hinged members (2, 3) and three locators (8) for the eyed article (30) wherein the elongate hinged members (2, 3) are movable into and out of contact with one another and provide three cooperating passageways (20) for different sized threads when in contact with one another. The passageways (20) extend transversely of a longitudinal axis of the elongate hinged members (2, 3), each passageway (20) has an inlet (21) for a thread, an outlet (22) for the thread, the outlet (22) being smaller than the inlet (21). The locators (8) can position an eye of an eyed article (30) in alignment with the respective outlets so that the thread may be run there through to include through the eyelet. The locators (8) being sized for different sizes of eyelets. The elongate hinged members (2,3) are opened so as to release the thread and the eyelet being threaded after which the thread may be tied about the eyelet of the eyed article (30).

### CROSS-REFERENCE TO RELATED APPLICATIONS

The present application claims priority to Australian patent application 2007200565 entitled Threading Tool filed on Feb. 9, 2007, and further based upon AU provisional applications 2006900704 being filed on Feb. 14, 2006 and 2006905282 being filed on Sep. 25, 2006 by the same inventor.

### BACKGROUND OF THE INVENTION

1. Field of the Invention

The present invention relates generally to tools and methods of threading eyes of eyed articles, and, relates, more particularly, to tools and methods of threading fish hooks.

2. Description of the Prior Art

Because of normal fishing conditions, the task of threading fish hooks is a required duty of every fisherman. Fish hooks become separated from the lines for numerous reasons including the hooks becoming ensnared in weeds and debris and breaking off when pulled, the fish breaking the line, and even changing hook types to meet the conditions and fish in the area. Running the line or thread through the eye or eyelet of the fish hook may be difficult under the circumstances including a rocking boat, windy weather, poor lighting conditions, very small eyelets, shaking hands for various reasons, poor eye sight, etc.

In a related problem, for example, there is a needle threading device that is a flexible wire-formed loop with a pointed apex. A small handle is attached to the wire ends. The apex is pushed through the needle eye until it expands again. The thread is placed through the expanded loop and the loop pulled back through the needle eye to result in the threaded needle. The use of such a device in the outdoors is equally affected by the conditions noted above.

A prior device for threading fish hooks is shown in U.S. Pat. No. 6,625,921 entitled “Fishhook Threader” issued on Sep. 30, 2003 and is incorporated by reference. The frustoconical-shaped funnel has a slot down the wall along the entire side. The eyelet of the fishhook is inserted into the slot and moved downward to be near the bottom exit. The wall being sufficiently flexible to hold the shank of the fish hook. At that point the fishing line is inserted into the top opening of the funnel and pushed downward and through the eyelet at the bottom of the funnel. The funnel guiding the line to the position where the eyelet is held near the bottom exit. After the line goes through the eyelet, the fish hook can be easily removed from the funnel-like device. It would appear that a very light line may become stuck within the smaller area of the funnel since there may be some nature twist in the line, static, wetness, or even dirt therein, and that the eyelet itself may stop the line going through the eye. Thus multiple attempts may be required to successfully thread the fish hook with this device. Further, due to its flexible design, the funnel may become bent or damaged in storage or while being carried.

Another prior device for threading fish hooks is shown in U.S. Pat. No. 5,383,695 entitled “Device for Securing a Hook to a Line” issued on Jan. 24, 1995, and is incorporated by reference. In this device, two slotted large conical recesses are provided for two different sizes of eyelets. The eyelet of the hook is held within a conical recess between two rotating members. The top surface of the upper member has the slotted larger conical recesses. After the eyelet is placed within the recess on the lower member, the upper member is rotated to prevent the eyelet from being removed and further aligning the openings in each of the two members for inserting the line therethrough. It would appear that this device has a limited range of eyelet sizes available with two options being shown.

Another prior device for threading fish hooks is shown in Great Britain Patent 722,366 entitled “Device for Threading the Eyes of Small Fish-hooks and other Eyed Article,” published on Jan. 26, 1955, and is incorporated by reference. This device comprises two hinged blocks having a single threaded guide duct being of a v-shaped groove running parallel to the hinge with an enlarged opening on one end and a positioning v-shaped notch on the other end. The fish hook eyelet is pushed against the v-shaped notch thus allowing the inserted line to be guided through the eyelet. In order to accommodate multiple sizes of eyelets and line sizes, the v-shaped notch is sufficiently large as well as the guide duct. In this regard, thin lines may become tangled or bent or twisted in the guide duct and further not necessarily go through the positioned eyelet when exiting the guide duct if the eyelet is not exactly in the right position. Further, the holding spring for the hook may be bent, loosened, or damaged making it difficult to insert and remove the hooked article without possible injury.

Accordingly, there is an established need for an improved hook threading device or tool and method that provides improvements over the prior devices.

### SUMMARY OF THE INVENTION

The present invention is directed at a threading device and method of threading eyed articles, and, in particular, fish hooks.

In operation, the present invention provides a threading tool for threading an eyelet of an eyed article where the threading tool has a pair of cooperating elongate hinged members, an upper elongate member and a lower elongate member, wherein the elongate hinged members are movable into and out of contact with one another in a jaw-like manner, each of the elongate hinged members having a contact surface thereon; a plurality of passageways for a thread are integrally formed in and extend transversely of a longitudinal axis of said elongate hinged members, each of said passageways has an inlet for the thread, an outlet for the thread, the outlet being smaller than the inlet in diameter, each passageway being able to communicate with threads having a range of sizes; associated with each passageway is a locator being able to position an eyelet of an eyed article in alignment with an outlet, each of the locators being adapted to hold eyelets having a range of sizes.

The present invention further provides means for a threading tool and method having a pair of cooperating elongate hinged members and three locators for the eyed article wherein the elongate hinged members are movable into and out of contact with one another and provide three cooperating passageways for different sized threads when in contact with one another. The passageways extend transversely of a longitudinal axis of the elongate hinged members, each passageway has an inlet for a thread, an outlet for the thread, the outlet being smaller than the inlet. The locators can position an eye of an eyed article in alignment with the respective outlets so that the thread may be run there through to include through the eyelet. The three locators are able to hold different size ranges of eyelets. The elongate hinged members are opened so as to release the thread and the eyelet being threaded after which the thread may be tied about the eyelet of the eyed article.

It is an object of the present invention to provide a threading tool and method of threading eyed articles;

It is another object of the present invention to provide a threading tool for threading fish hooks.

It is a further object of the present invention to provide a threading tool for threading fish hooks wherein the threading tool is capable of holding eyelets of the fish hooks having a range of sizes and having a range of thread sizes for the eyelets.

It is still a further object of the present invention to provide a threading tool that is operable under a wide range of conditions.

It is yet a further object of the present invention to provide a threading tool that is easily constructed from molded plastic materials, that is capable of handling a wide range of fish hook sizes with a minimum of three passageways; and is easily operated under adverse conditions.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a front perspective view of a threading tool wherein cooperating upper and lower elongate hinged members of the tool are shown in contact with one another, according to one embodiment of the invention;

FIG. 2 is a front perspective view of the threading tool shown in FIG. 1 having the upper and lower elongate hinged members in an open position;

FIG. 3 is a rear perspective view of the threading tool shown in FIG. 1, but further showing (in phantom) in one location a fish hook and line relative to the tool;

FIG. 4 is a rear perspective view of the threading tool shown in FIG. 2;

FIG. 5 is a detailed front elevation view of the lower elongate member shown in FIG. 1;

FIG. 6 is a top plan view of the lower elongate member shown in FIG. 5;

FIG. 7 is a detailed right end elevation view of the lower elongate member shown FIG. 5;

FIG. 8 is a front elevation view of the upper elongate member shown in FIG. 1;

FIG. 9 is a detailed top plan view of the upper elongate member shown in FIGS. 1 and 8;

FIG. 10 is a rear perspective view of a threading tool according to another embodiment of the present invention; and

FIG. 11 is another rear perspective view of the threading tool shown in FIG. 10, but having the elongate hinged members in an open position.

Like reference numerals refer to like parts throughout the several views of the drawings.

### DETAILED DESCRIPTION OF THE INVENTION

The present invention is directed at a tool and method for threading an eye or eyelet of an eyed article.

In one embodiment of the invention, the threading tool is in the form of a portable hand tool. Further, the threading tool may be adapted for attachment to another article or fixture, such as a boat, tackle box or key ring. The threading tool may have a mount to facilitate its attachment to another article or fixture. Any suitable type of mount may be used, e.g., fasteners or adhesives. The threading tool may have a tab having an aperture enabling it to be connected to a key ring. The tab may extend from one of the elongate members.

In yet another embodiment of the invention, the threading tool may be part of, or incorporated into, another article or fixture. For example, the tool may be molded into a lid of a tackle box or incorporated into a handle of a pair of scissors or pliers. The elongate members may be of any suitable size, shape and construction. Preferably, each elongate member is a block and the block is substantially oblong in shape. The elongate members may be moved into and out of contact with one another in any suitable way. When in contact with one another, the elongate members provide the passageway for the thread, and when not in contact, the thread may be removed from the passageway. Preferably, the elongate members move within substantially the same plane as one another.

The elongate members may pivot relative to each other in much the same way as a thumb and an index finger of a hand may move relative to one another. Preferably, the threading tool comprises a hinge and an end of each elongate member is hinged together and thus each elongate member may have a hinged end and an unhinged end. The hinge may be of any suitable size, shape and construction. Preferably, the hinge comprises a yoke extending from the hinged end of one of the elongate members, and a hinge pin extending through the yoke as well as through an aperture in the hinged end of the other elongate member.

The threading tool may have a handle extending from one or more of the elongate members. The handle may be of any suitable size, shape and construction. Preferably, a handle extends from the unhinged end of one of the elongate members.

The threading tool may have one or more guides for accurately positioning the elongate members relative to one another, when in contact with each another. The guides may be of any suitable size, shape and construction. Preferably, a pair of guide tabs extend upwardly from the unhinged end of one of the elongate members and the handle of the other elongate member is locatable between the tabs.

The passageways provided by the elongate members may be of any suitable size and shape. The size and shape may depend on the diameter and cross-sectional shape of the thread. The thread may be, for instance, a wire. a nylon line, or a cotton or woolen string. The passageways may be provided by a groove in one or both of the elongate members. Preferably, one half of the passageway is provided by a respective groove in each elongate member. Preferably, a central axis of the passageway extends perpendicularly of the longitudinal axis of the elongate members.

The inlet of the passageway is preferably tapered. The inlet may be, for example, cone-shaped or pyramid-shaped. Preferably, the outlet is only slightly larger than the thread passing through it. More preferably, the passageway is in the shape of a funnel.

The locator may be of any suitable size, shape and construction. The locator may be separately formed from one or more of the elongate members or integrally formed with one or more of the elongate members. In one embodiment, the locator is a recess formed in one of the elongate members and the recess is located adjacent the outlet of the passageway. The eyed article may be placed within the recess and the recess may position the eye thereof in alignment with the outlet. The locator may prevent the eyed article from moving out of alignment with the outlet by accident and this may be achieved in any suitable way. For instance. a wall or other type of projection spaced from the outlet may prevent the eyed article from moving out of the recess.

In another embodiment, the locator may be, or may include, a magnet. Any suitable type of magnet may be used and the magnet may be located at any suitable location. Preferably, a magnet is located above the outlet and holds the eye of the eyed article in alignment with the outlet. The magnet may be, for instance, in the shape of a disk or a strip. More preferably, the locator comprises both a recess below the outlet and a magnet above the outlet.

The elongate members can provide any suitable number of passageways. Preferably, the elongate members provides at least two, and more preferably three passageways that extend adjacent one another transversely of the longitudinal axis of the elongate members. Preferably, the outlets of the passageways differ in size (diameter) from one another so that threads of differing diameter may be accommodated. Likewise, preferably the locator recesses differ in size from one another so that different sized eyed articles can be threaded. Preferably, the passageway having the smallest outlet also has the smallest locator recess.

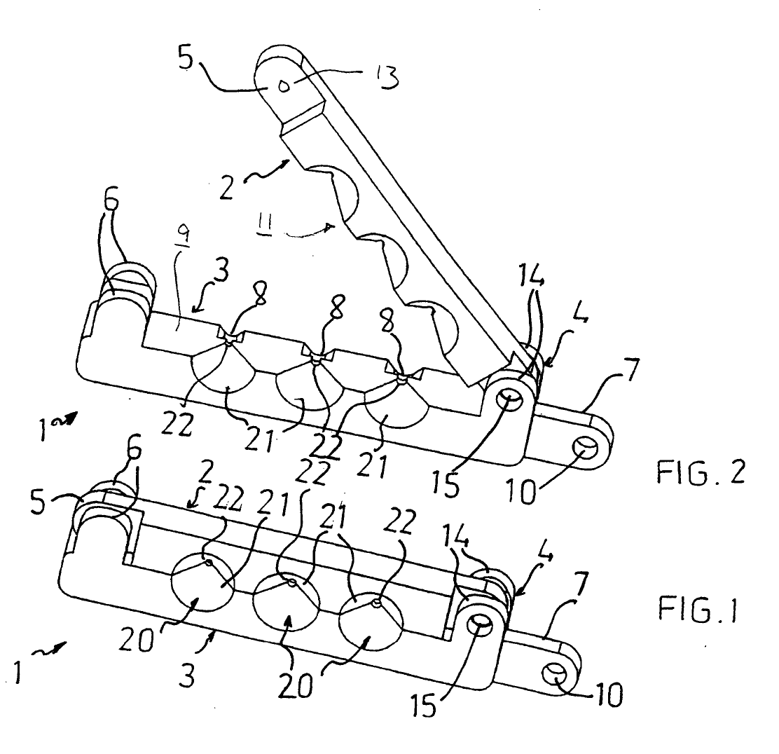

Turning to the drawings, wherein like components are designated by like reference numerals throughout the various figures, attention is initially directed to FIG. 1 which illustrates a threading tool 1 of the present invention.

The threading tool 1, shown in a closed position in FIG. 1 and in an open position in FIG. 2, has an upper elongate member 2, a lower elongate member 3, a hinge 4, a handle 5, a pair of guide tabs 6, a mounting tab 7, and locators 8. The hinge 4 enables the elongate members 2 and 3 to pivot like jaws within a common plane into and out of contact with one another on a lower contact surface 9 and an upper contact surface 11.

The tool 1 may be made of molded plastics, preferably, but other materials such as aluminum may be used. Each elongate member 2 and 3 is a substantially oblong block having a longitudinal axis perpendicular to the axis of rotation, a hinged end and an unhinged end.

The pair of guide tabs 6 are spaced from one another and extend upwardly from the unhinged end of the lower elongate member 3. A detent means 13 may be placed on the handle 5 to insure that the upper elongate member 2 is securely held within the guide tabs 6 by means of a groove therein. The handle 5 extends from the unhinged end of the upper elongate member 2 and is located between the guide tabs 6 when the elongate members 2, 3 are in contact with one another. The mounting tab 7 extends from the hinged end of the lower elongate member 3 along the longitudinal axis of the lower elongate member 3. The mounting tab 7 has an aperture 10 for attachment to a key ring or a cord or other carrying means.

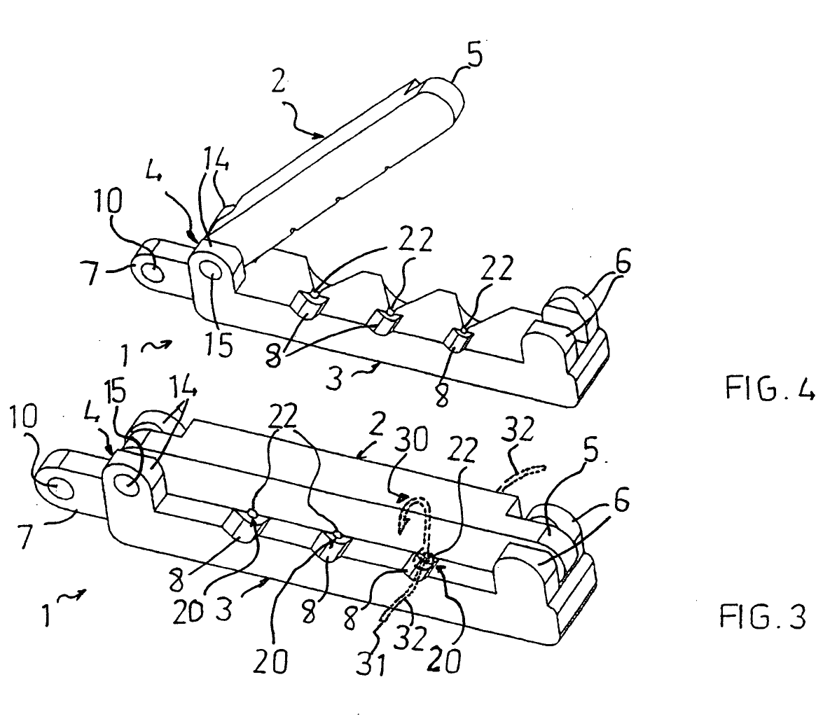

The hinge 4 comprises a yoke 14 and a pin 15. The yoke 14 extends upwardly from the hinged end of the lower elongate member 3. The pin 15 extends through the yoke 14 as well as through an aperture in the hinged end of the upper elongate member 2 (FIG. 9). The elongate members 2 and 3 provide three passageways 20 when in the closed position for passing a thread when in contact with one another, as seen in FIGS. 1 and 3. The passageways 20 are provided by grooves in both elongate members 2 and 3 and each passageway 20 extends transversely of the longitudinal axes of the elongate members 2 and 3. A central axis of each passageway 20 extends perpendicularly of the longitudinal axes of the elongate members 2 and 3. One half of each passageway 20 is provided by a respective groove in each elongate member 2 and 3 being divided by the lower or upper contact surfaces 9 or 11 respectively.

Each passageway 20 has an inlet 21 for the thread and an outlet 22 for the thread. Each passageway 20 is in the shape of a funnel, wherein the outlet 22 is much smaller than the inlet 21. The diameter of each outlet 22 differs for the purpose of optimally passing threads of different diameters that are further related to different sizes of eyelets. The outlet 22 proximal to the guide posts 6 has the smallest diameter and the outlet 22 most distal has the largest diameter. This arrangement may be reversed.

It should be understood by one skilled in the art that fish hooks come in a wide variety of sizes including the eyelet attached thereto. Further, the optimal line size also varies according to the hook size. The present invention is thus directed at a tool that is capable of handling a range of hook sizes as well as the related line or thread size as contrasted to the prior art devices. It is therefore possible to have more than one tool of the present invention in the tackle box. In the embodiment shown, there are three passageways and three recesses for the eyelets of various fish hooks. In particular, the smallest recess will take hook sizes 12 to 6; the middle recess with take sizes 8 to 2; and the largest recess will take sizes 6 to 2/0. The manufactures of fish hooks may different on the sizes of the hooks and thus there should be provided greater flexibility by the threading tool 1.

The tool 1 has locators 8 situated adjacent to and oppositely positioned outlets 22 of each passageway 20. The locators 8 are positioned on the lower elongate member 3 only. The locator 8 positions an eye or eyelet of an eyed article in alignment with the outlet 22. Each locator 8 is an arcuate recess 8 formed in the lower elongate member 3. The size of each recess 8 differs for holding different diameter eyelets. The passageway 20 having the smallest outlet 22 also has the smallest recess 8 (see FIG. 6 illustrates the smallest recess closest to the hinge 4).

FIG. 4 clearly shows that the recesses 8 are not covered by the upper elongate member 2 when in the closed position. This allows a finger or thumb to hold the fish hook 30 in the recess 8 while the other hand is used to feed the line 32 into the inlet 21.

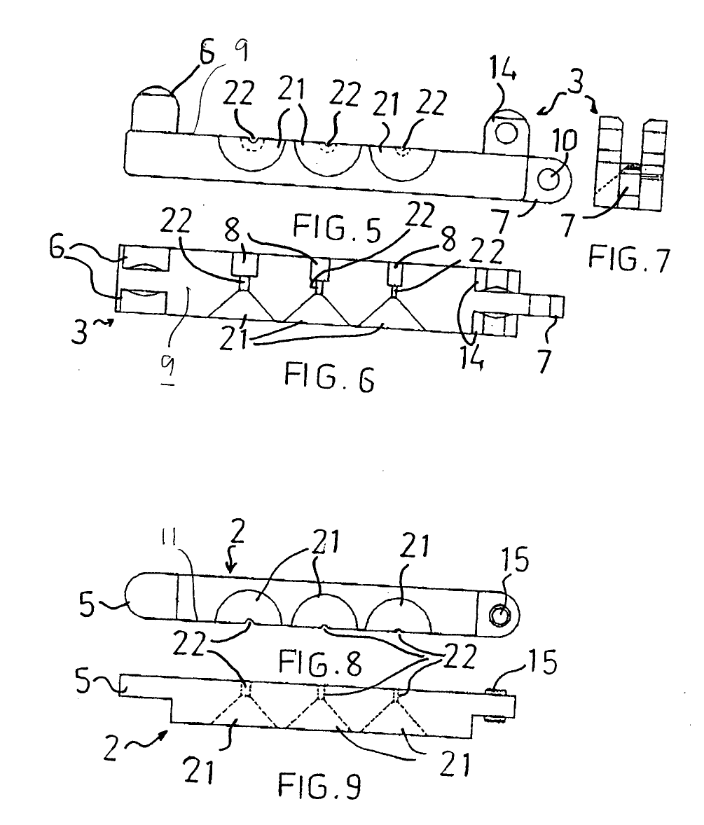

FIGS. 5, 6 and 7 illustrate different views of the lower elongate member 3. FIGS. 8 and 9 illustrate different views of the upper elongate member 2, FIGS. 5 and 8 being the same view of the members, and FIGS. 6 and 9 being the same view of the members.

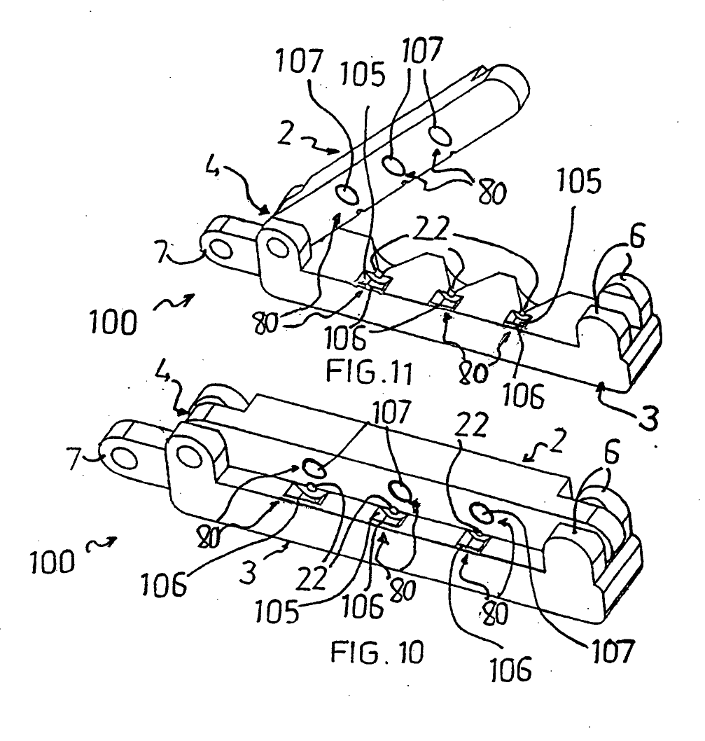

FIGS. 10 and 11 show a threading tool 100 that is substantially the same as tool 1. The tool 100 has an upper elongate member 2, a lower elongate member 3, a hinge 4, a pair of guide tabs 6, a mounting tab 7, and locators 80. The hinge 4 enables the elongate members 2 and 3 to pivot within a common plane into and out of contact with one another.

The elongate members 2 and 3 provide three passageways (not labeled) for a thread when in contact with one another, as seen in FIG. 10. Each passageway has an inlet (not labeled) for the thread and an outlet 22 for the thread. A locator 80 positions an eye of an eyed article in alignment with the outlet 22. Each locator 80 comprises an arcuate recess 105 formed in the lower elongate member 3. The size of each recess 105 differs. Each recess 105 is bordered by a wall 106 which prevents the eyed article from moving (slipping) from the desired location by accident.

Each locator 80 also comprises a magnetic disk 107 located in a cavity in the upper elongate member 2. The magnetic disk 107, together with the recess 105, holds the eyed article at the desired location without hand assistance. Of course, the magnetic disk 107 could also be used independently of a recess 105.

The tool 1 can thread, for example, a nylon fishing line through an eye of a fish hook. In use, the elongate members 2 and 3 are moved into contact with one another as shown in FIG. 1. A fish hook 30 with an eyelet, shown in phantom in FIG. 3, is placed within the locator recess 8 such that an eye or eyelet of the fish hook 30 is in axial alignment with the outlet 22 of the passageway 20. A leading end 31 of a thread 32 is then passed through the eye by way of the passageway 20. The thread 32 is removable from the passageway 20 upon rotating the elongate members 2 and 3 out of contact with one another (as shown in FIG. 4). A knot is then tied in the thread 32 to retain the fish hook 30.

An advantage of the present invention is that eyed articles may be readily threaded, even if there is poor visibility or if the threader is not on steady ground. The tool 100 is particularly suitable for use by those who have arthritic hands or otherwise limited hand movement.

Another advantage of the present invention is that it may have multiple passageways and hence it may be used to thread different size eyed articles. Yet another advantage of the present invention is that it is quite compact. Hence, it is easy to handle, store and transport. Alternatively, the threading tool may be attached or incorporated into another article or fixture, such as a boat or tackle box.

Since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A threading tool for threading an eyelet of an eyed article, said threading tool comprising:
a pair of cooperating elongate hinged members, an upper elongate member and a lower elongate member, wherein said elongate hinged members are movable into and out of contact with one another in a jaw-like manner, each of said elongate hinged members having a contact surface thereon;
a plurality of passageways for a thread, wherein said passageways are integrally formed in and extend transversely of a longitudinal axis of said elongate hinged members, each of said passageways has an inlet for the thread, an outlet for the thread, the outlet being smaller than the inlet in diameter, each passageway being able to communicate with threads having a range of sizes; and
a plurality of locators being able to position an eyelet of an eyed article in alignment with an outlet, each of said locators being adapted to hold eyelets having a range of sizes.

2. The threading tool according to claim 1, wherein said plurality is three in number.

3. The threading tool according to claim 1, further comprising a hinge and an end of each said elongate member hinged together.

4. The threading tool according to claim 3, wherein said hinge comprises a yoke extending from a hinged end of one of said elongate members, and a hinge pin extending through said yoke as well as through an aperture in said hinged end of said other elongate member.

5. The threading tool according to claim 1, further comprising a handle extending from one or more of said elongate members.

6. The threading tool according to claim 5, wherein said handle extends from an unhinged end of one of said elongate members.

7. The threading tool according to claim 1, further comprising, one or more guides for accurately positioning said elongate members relative to one another when in a closed position.

8. The threading tool according to claim 7, wherein said guides comprise a pair of guide tabs extending upwardly from said unhinged end of one of said elongate members and said unhinged end of said other elongate member is locatable between said tabs when in said closed position.

9. The threading tool according to claim 1, wherein each of said locators is a recess formed in said lower of said elongate members and in said contact surface thereof, each recess being located adjacent one of said outlets of one of said the passageways when said members are in a closed position, said recess being exposed when said members are in said closed position.

10. The threading tool according to claim 9, wherein each of said locators comprises a wall or other type of projection spaced from the outlet that prevents the eyed article from moving out of said recess.

11. The threading tool according to claim 9, further including a magnet with each of said locators for removably holding said eyed article.

12. The threading tool according to claim 11, wherein said magnet is located above the outlet and in said upper member without said recess therein.

13. The threading tool according to claim 1, wherein one half of each of said passageways is provided by a respective groove in each of said elongate members, wherein said contact surfaces divide said passageways in half.

14. The threading tool according to claim 1, wherein a central axis of each of said passageways extends perpendicularly of said longitudinal axis of said elongate members.

15. The threading tool according to claim 1, wherein said inlet of each of said passageways is tapered.

16. The threading tool according to claim 15, wherein said inlet is cone-shaped or pyramid-shaped or funnel-shaped.

17. The threading tool according to claim 1, wherein said eyed articles are fish hooks.

18. A method of using a threading tool as defined in claim 1 to thread an eyelet of an eyed article, said method comprising the steps of:
selecting the eyed article;
placing an eyelet in an appropriate locator, the threading tool having a plurality of locators, the threading tool being a closed position;
selecting an appropriate sized thread for the eyelet;
running the thread through the passageway associated with said placed eyelet and through said eyelet within said locator; and
opening said pair of elongate hinged members and removing therefrom the threaded eyed article.

19. The method according to claim 18, wherein the locator includes having a magnet for holding the eyed article in the locator.

20. The method according to claim 19, wherein the eyed article is a fish hook.
